(19) United States
(12) Patent Application Publication
(10) Pub. No.: US 2007/0235441 A1
(43) Pub. Date: Oct. 11, 2007

(54) Insulating glass unit construction with an electrically heated pane

(76) Inventor: Jeffrey Winsler, Sarasota, FL (US)

Correspondence Address: HOLLAND & KNIGHT LLP;ATTN: STEFAN V. STEIN/ IP DEPT., POST OFFICE BOX 1288, TAMPA, FL, 33601-1288, US

(21) Appl. No.: 11/390,968

(22) Filed: Mar. 28, 2006

(51) Int. Cl. H05B 3/06

(52) U.S. Cl. 219/522; 219/219

(57) ABSTRACT

Disclosed is the construction of an insulating glass unit (“IGU”) utilizing two or more glass panes. The construction employs powered bus bars and connecting wires to deliver a voltage to a resistive coating that is applied to one of the panes. The voltage heats the area between two of the panes and thereby reduces condensation on the outer surface of the IGU. In accordance with the present invention, the bus bars are secured within a sealant at a location that is outside of the spacer and the viewing area of the pane. This arrangement increases the total viewing area and eliminates the risk of electric shock in the event the pane is broken, and eliminates moisture from entering the IGU leading to failure.

### BACKGROUND OF THE INVENTION

1. Field of the Invention

The present invention relates to the construction of an insulating glass unit. More specifically, the present invention relates to an insulating glass unit that is heated with an electric current.

2. Description of the Background Art

A common problem with glass refrigerator or freezer doors is the build up of condensation. This condensation can be caused by large temperature differences on opposing sides of the door or by high humidity levels on the outside of the door. This condensation is particularly objectionable in the case of commercial refrigerator doors as condensation precludes a consumer's view of items within the refrigerator. In addition, condensation on the glass results in wet floors creating a slip and fall hazard for the shopper or store employee.

Various constructions have been devised in an effort to overcome condensation build up. For example, two panes of glass can be assembled together with a space between the two panes. This construction is known as an insulating glass unit or “IGU.” The space between the two panes, which should be completely sealed from the environment, acts as an insulator and serves to keep the outer pane of glass at a higher temperature, thereby preventing the formation of condensation.

If the application becomes more severe in terms of temperature difference or relative humidity, three or more panes of glass can be assembled together, further increasing the temperature of the glass surface on the warm side. The temperature of the glass surface on the warm side can be further increased by changing the gas between the panes from air to some other gas, such as argon. In addition, specialty coatings (like Low E coatings) can be added to one or more of the glass surfaces to further increase the temperature of the glass and reduce condensation.

Some applications may still too severe to prevent condensation even using multiple panes of glass and specialty coatings. In this case, a transparent and electrically conductive coating can be applied to one of the pane surfaces. When a voltage is applied to opposing sides of this electrically conductive coating, current will flow across the coating. As the coating has a predetermined amount of electrical resistance, heat is generated in the coating, further increasing the temperature of the glass. The result is the elimination of condensation on the glass.

However, care must be taken to ensure that the electrical current is evenly distributed along the full length of both edges of the glass pane to ensure even heating. As noted in the prior art construction 10 of FIG. 2, an electrical bus bar 12 is adhered to a conductive coating 14 to provide for even distribution of current. A power wire 16 is attached to bus bar 12 using solder, compression clips, or any other number of ways as a means to connect electrical coating 14 to a power source (not shown). Bus bar 12 is placed inside an IGU spacer 18 and electrical coating 14 may be removed from the glass outside the boundary of bus bar 12.

Yet the use and positioning of this bus bar is disadvantageous in many respects. For instance, positioning the bus bar inside the spacer interferes with the sight line through the refrigerator or freezer door. Furthermore, the power wires attached to the bus bar must penetrate the spacer. The wires must further penetrate an IGU sealant that is used to join the panes of the IGU. These penetrations create a leak path for moisture to enter the IGU. This leak path is created by voids between the individual wire strands and by the absence of a bond between the wire and surrounding wire jacket. An additional leak path can be between the outer jacket of the wire and the sealant if the sealant does not adhere to the wire jacket. Although a desiccant can be added to the spacer to remove this moisture, over time this desiccant becomes saturated. Condensation then forms inside the IGU. Ultimately, the IGU must be replaced. Furthermore, running the wires through the spacer and sealant complicates the manufacturing process. Yet another drawback of this construction is that breaking either glass pane results in the exposure of both the powered wire and the bus bar. This, of course, creates an immediate and significant risk of electrical shock to both shoppers and maintenance technicians alike.

Thus, there exists a need in the art for an IGU with an improved construction, whereby viewing areas can be improved, construction techniques can be simplified and the dangers associated with electric shock can be eliminated. The present invention is aimed at fulfilling this need.

### SUMMARY OF THE INVENTION

It is therefore one of the objects of the present invention to eliminate the risk of electric shock associated with an electrically heated IGU.

It is another object of this invention to increase the total viewing area of an electrically heated IGU, whereby IGUs can be made smaller without sacrificing total viewing area.

It is also an object of the present invention to eliminate a leak path of moisture into an electrically heated IGU, thereby eliminating one of the IGU failure modes.

It is a further object of the present invention to enable an electrically heated IGU to be more quickly and easily manufactured and to thereby increase manufacturing productivity.

These and other objectives are realized in an insulating glass unit that includes a first pane of glass defined by a peripheral edge and upper and lower areas. The first pane constitutes an exterior pane of the insulating glass unit. A metallic or non-metallic spacer is positioned upon the first pane interior of the peripheral edge and the first and second areas. The spacer defines a viewing area and contains a desiccant for the removal of moisture. An electrically conductive and transparent coating is applied to the viewing area, with the coating containing a predetermined amount of resistance. A second pane of glass is also included, with the second pane similarly being defined by a peripheral edge and upper and lower areas. Likewise, additional panes can be added to the IGU. The last pane constitutes an interior pane of the insulating glass unit. A sealant is applied to the opposing surfaces of all the panes outside the spacer(s) and joins them together in an airtight manner to trap a volume of gas therebetween to keep moisture out. The desiccant absorbs any moisture within the gas. A bus bar is positioned within the sealant of the first area, and a second bus bar is positioned within the sealant on the opposite end of the IGU. These may correspond to the upper and lower areas accordingly. The bus bars together supply a voltage to the coating to heat the gas and the glass by way of the resistance in the coating. The placement of the first and second bus bars outside of the viewing area eliminates the danger of electric shock if the electrified glass were to be broken.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a view of an insulating glass unit of the present invention.

FIG. 2 is a view of a prior art bus bar employed on an insulating glass unit.

FIG. 3 is a view of the bus bar of the present invention employed on an insulating glass unit.

FIG. 4 is a side elevational view of another insulating glass unit of the present invention.

Similar reference characters refer to similar parts throughout the several views of the drawings.

### DETAILED DESCRIPTION OF THE PREFERRED EMBODIMENT

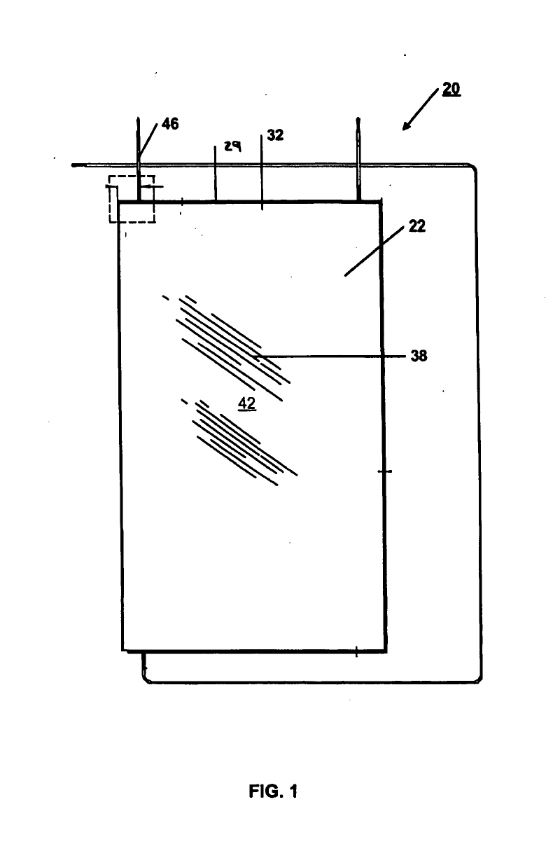

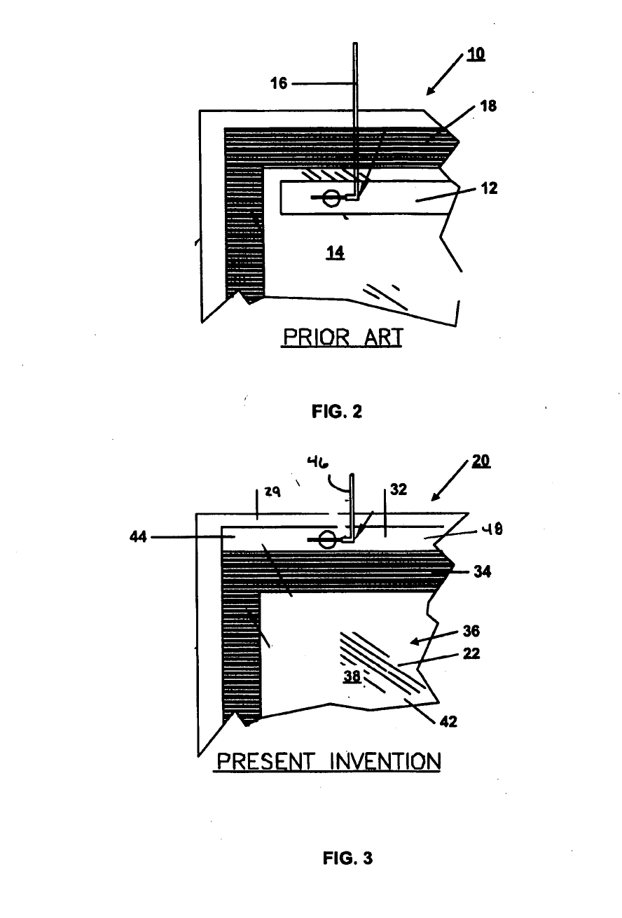

The present invention relates to the construction of an insulating glass unit (“IGU”) utilizing one or more glass panes. The construction employs powered wires and bus bars to deliver a voltage to a resistive coating that is applied to one of the panes. The voltage drop across the pane heats the glass and thereby eliminates condensation on the outer surface of the IGU. In accordance with the present invention, the bus bars are secured to the glass within the sealant at a location that is outside of the viewing area of the pane. This arrangement increases the total viewing area and eliminates the risk of electric shock in the event the pane is broken. The present invention is more fully described herein in conjunction with FIGS. 1-4.

FIG. 1 illustrates an IGU 20 of the present invention. The depicted IGU 20 can take the form of a refrigerator or freezer door or viewing window. These doors are used within stores (such as supermarkets, convenience stores, liquor stores, etc.) and allow consumers to access refrigerated areas where perishables or other cold items are kept. However, IGU 20 of the present invention finds application in other environments as well, such as household refrigerator doors. The invention can be used on any glass enclosure that benefits from the elimination of condensation.

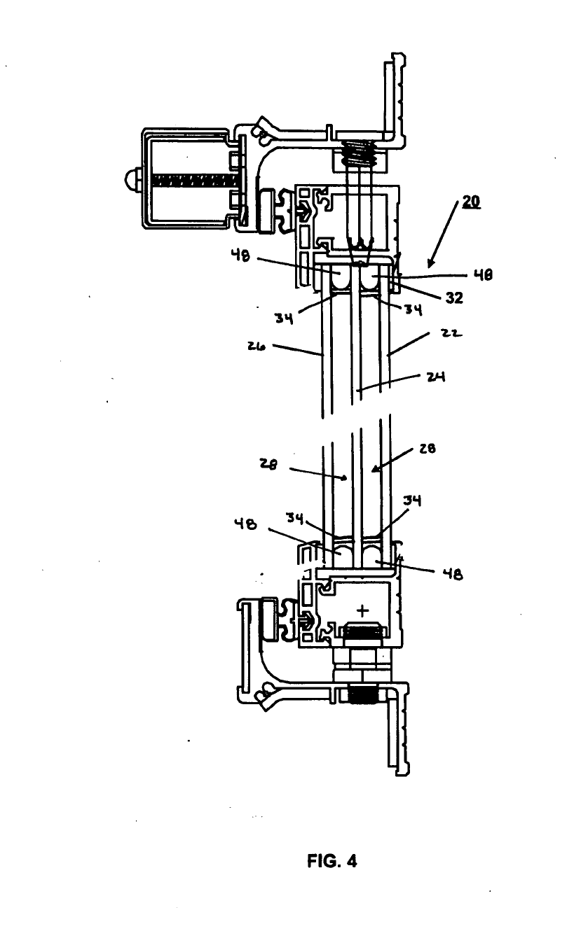

As is known in the art, an IGU can be composed of one or more glass panes with an associated number of intermediate insulating areas. As noted in FIG. 4, the present invention is described in conjunction with IGU 20 that includes first and second and third panes (22, 24, and 26 respectively), one of which is heated. IGU 20 includes an interior insulating spaces 28 positioned between panes 22 and 24 and between panes 24 and 26. First pane 22 is preferably the heated pane of IGU 20 and is located on the exterior side of IGU 20. It is nonetheless within the scope of the present invention to heat any of the panes 22, 24, or 26. The exact structure of the IGU employed in carrying out the present invention will be dictated by the intended use, the temperature difference between the inner and outer panes, and the relative humidity of the environment.

FIG. 3 is a detailed view of a portion of first pane 22 and its associated peripheral edge 29. The depicted pane is rectangular in shape, although it will be obvious to those of ordinary skill that panes of different sizes and shapes can be used in carrying out the principles of the invention. First pane 22 also includes first and second areas. Second and third panes 24 and 26 likewise includes a peripheral edge and first and second areas. These areas are for use in securing bus bars in a manner that will be described more fully hereinafter. In the preferred embodiment, the first and second areas are located at the upper and lower portions of the panes adjacent the peripheral edges. FIG. 3 illustrates the upper area 32 of first pane 22. The other areas are not depicted insomuch as they are identical to this upper area 32. Although described as being the upper and lower portions of the panes, the first and second areas can just as readily be located on the opposing sides of the pane.

With reference again to FIG. 3, the spacer 34 positioned upon the pane is illustrated. In the preferred embodiment, a non-metallic spacer 34 is employed that contains a desiccant for removing moisture from the interior of IGU 20. A metallic spacer electrically disconnected from the coating 42 of panel 22 can also be used. The desiccant prevents excess moisture from building up within IGU 20. Such moisture would result in the formation of condensation inside the IGU and, ultimately, the failure of IGU 20. Spacer 34 approximates the shape of the surrounding pane 22 and can be, for example, rectangular in shape. However, the use of spacers 34 of varying shapes and sizes is within the scope of the present invention. Spacer 34 is positioned interior of both the peripheral edge 29 and the first and second areas. This holds true whether the first and second areas are located at the upper 32 and lower portions of the pane 22 or at the opposing sides of the pane 22. The internal area 36 bounded by spacer 34 constitutes the viewing area 38 of IGU 20 and allows consumers to view merchandise through the refrigerator door.

With continuing reference to FIG. 3, the coating 42 of pane 22 is described. This coating 42 is electrically conductive and preferably fully transparent so as to enable consumers to clearly see through the viewing area 38. Ideally, coating 42 is applied to the entire viewing area 38 of pane 22. Namely, coating 42 is applied to pane 22 and extends to near the edge of the glass. Coating 42 has a predetermined amount of resistance such that when a voltage is applied to coating 42 heat is generated.

The IGU 20 is created by sealing together the panes (22, 24 and 26) as noted in FIG. 4. Specifically, a sealant 48 is applied to the peripheral area around the panes (22, 24 and 26) to join them together in an airtight manner and trap a volume of gas in space 28. Sealant 48 is also applied to the first and second areas as defined above. The airtight space 28 between the panes entrains gas and functions to insulate IGU 20 and prevent condensation. Again, as noted above, the desiccant provided as part of spacer 34 is exposed to space 28 to absorb any excess moisture.

With reference to FIG. 3, one of the wires 46 is depicted. However, two wires are ideally employed, with each wire being positioned at opposing upper and lower locations upon pane 22. Additional wires can be attached to either the upper or lower bus bar to accommodate alternate door designs. FIG. 3 specifically illustrates a wire 46 secured to the first area at the upper portion 32 of pane 22. The second wire at the lower portion of pane 22 is not depicted but is similar to first wire 46 in all respects. In the preferred embodiment, portions of these wires along with the entirety of the first and second bus bars are secured within the sealant 48 of the first and second areas. Two wires provide power to the bus bars which results in uniform voltage being applied to the coating 42. This, in turn, results in an even heating of IGU 20. This objective can also be achieved with bus bars that are secured within the sealant 48 at opposing sides of the pane 22. Either way, heat is generated within space 28 of IGU 20 as the voltage encounters the resistance within coating 42. Wherever wire 46 and bus bar 44 are secured, they should be positioned outside of spacer 34 and outside of the viewing area 38 of the pane.

It has been discovered that this placement of the wires is advantageous for a number of reasons. First, by placing the bus bar outside of viewing area 38, an IGU can be made smaller while retaining the same overall viewing area. In other words, by removing the bus bars from the viewing area 38, the viewing area is substantially increased. Second, the placement of the bus bars outside the viewing area 38 eliminates the danger of electric shock. Namely, placing the bus bars within the viewing 38 area leaves open the possibility that in the event the glass pane is broken, the powered bus bars 44 and connecting wire 46 are exposed. Placing the bus bars outside of the spacer 34 eliminates this possibility because the bus bar 44 and connecting wires 46 are secured within the sealant 48. Third, by placing the bus bars within the sealant 48, the wires 46 can be secured after the panes (22, 24 and 26) have been joined, thereby reducing manufacture steps and increasing productivity. Fourth, the placement of the bus bars 44 and connecting wires 46 outside the spacer 34 eliminates the leak path for moisture to enter the IGU 20 between the individual strand(s) of wire and the wire jacket of the connecting wire 46 or between the wire jacket of the connecting wire 46 and the sealant 48, thus extending the life of the IGU 20.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. An insulating glass unit comprising:
a first pane of glass defined by a peripheral edge and upper and lower areas, the first pane constituting an exterior pane of the insulating glass unit;
a spacer positioned upon the first pane adjacent the peripheral edge, the spacer containing a desiccant, a viewing area bounded by the spacer;
an electrically conductive and transparent coating applied to the glass pane, the coating having a predetermined amount of resistance;
a second pane of glass defined by a peripheral edge and upper and lower areas, the second pane constituting an interior pane of the insulating glass unit;
a sealant applied to the upper and lower areas of the first and second panes, the sealant functioning to join the panes in an airtight manner and trap a gas therebetween, the desiccant absorbing any moisture within the space;
a first bus bar positioned within the sealant of the upper area, a second bus bar positioned within the sealant of the lower area,
wires supplying a voltage to the first and second bus bars and the coating to heat the first pane by way of the resistance in the coating, whereby the placement of the first and second bus bars outside of the viewing areas eliminates the danger of electric shock in the event the glass is broken.

2. A device for reducing condensation comprising:
a pane of glass defined by a peripheral edge and a peripheral area;
a spacer positioned upon the pane interior of the peripheral edge and the peripheral area, a viewing area bounded by the spacer;
an electrically conductive coating applied to the glass, the coating having a resistance;
a sealant applied to the peripheral area;
a bus bar positioned within the sealant, the bus bar supplying a voltage to the coating to heat the pane by way of the resistance in the coating, whereby the placement of the bus bar outside of the viewing area eliminates the danger of electric shock.

3. The device as described in claim 2 wherein two or more panes of glass are included which are joined together by the sealant and wherein the two panes together constitute an insulating glass unit.

4. The device as described in claim 3 wherein the spacer includes a desiccant for eliminating moisture from within the insulating glass unit.

5. The device as described in claim 2 wherein the peripheral area is at an upper portion of the pane.

6. The device as described in claim 2 wherein the peripheral area is at a lower portion of the pane.

7. An insulating glass unit comprising:
first and second panes of glass, each pane defined by a peripheral edge, the first and second panes together constituting the insulating glass unit with one pane forming an exterior surface and the other pane forming an interior surface;
a spacer positioned upon one of the panes interior of the peripheral edge, a viewing area bounded by the spacer;
an electrically conductive and transparent coating applied to the glass;
a sealant functioning to join the first and second panes in an airtight manner;
a bus bar positioned outside of the viewing area and within the sealant, the bus bar coupled to a source of power for supplying a voltage to the coating to heat the first and second panes.
